(19) United States
(12) Patent Application Publication
(10) Pub. No.: US 2005/0185330 A1
(43) Pub. Date: Aug. 25, 2005

(54) Disk clamping apparatus for data storage device

(75) Inventors: Chul-woo Lee, Seongnam-si (KR); Tatsuo Nakamoto, Suwon-si (KR); Jae-myung Jung, Suwon-si (KR); Ki-tag Jeong, Hwaseong-si (KR); Dae-sik Hong, Suwon-si (KR); Han-rae Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/994,278

(22) Filed: Nov. 23, 2004

(30) Foreign Application Priority Data
Feb. 19, 2004 (KR) 2004-11009

(51) Int. Cl. G11B 17/08; G11B 17/02; G11B 33/14

(52) U.S. Cl. 360/99.12; 360/97.02; 360/98.08

(57) ABSTRACT

A disk clamping apparatus for a data storage device fixing at least one disk onto a spindle motor, and having: a clamp combined with the spindle motor and applying pressure onto the disk in a first direction, an outer circumference of the clamp contacting a first part of the disk; and a damper installed between the clamp and the spindle motor to damp impact and vibration delivered to the disk via the clamp. The damper is made of a visco-elastic material and adhered to at least one of a bottom of the clamp or an upper part of the hub. Accordingly, it is possible to damp impacts and vibration delivered to the disk via the clamp, thereby reducing an incidence of the disk bumping against a head, and reducing deterioration of performance of the head.

### CROSS-REFERENCE TO RELATED APPLICATIONS

This application claims the benefit of Korean Patent Application No. 2004-11009, filed on Feb. 19, 2004, in the Korean Intellectual Property Office, the disclosure of which is incorporated herein by reference.

### BACKGROUND OF THE INVENTION

1. Field of the Invention

The present invention relates to a data storage device, and more particularly, to a disk clamping apparatus to fix a disk storing data to a spindle motor.

2. Description of the Related Art

An apparatus, such as a hard disk drive (HDD) or an optical disk drive (ODD), records data on and/or reproduces data from a disk that is loaded onto a spindle motor and rotated.

FIG. 1 is a schematic view of a conventional HDD. The HDD of FIG. 1 includes a base member 11. A spindle motor 30 that rotates disks 20 that are data storage media, and an actuator 40 that moves read/write heads (not shown) to desired positions of the disks 20 to perform a read/write operation, are installed on the base member 11.

FIG. 1 illustrates that two disks 20 are loaded onto the spindle motor 30. But a single disk, three disks, or more disks may be loaded onto the spindle motor 30. For a case where a plurality of disks 20 are loaded onto the spindle motor 30, a ring-shaped spacer 50 is inserted among the plurality of disks to maintain a distance between respective disks 20. An upper part of the spindle motor 30 is engaged with a clamp 60 via a screw 70, so that the disks 20 can be firmly fixed onto the spindle motor 30.

The actuator 40 includes: a swing arm 42 combined with a pivot 41 installed on the base member 11, such that the swing arm 42 rotates with respect to the pivot 41; a suspension 43 fixed with an end of the swing arm 42 to support a slider (not shown) with the heads so that the slider is elastically biased toward surfaces of the disks 20; and a voice coil motor (VCM) 45 that rotates the swing arm 42. The VCM 45 is controlled by a servo control system (not shown). The VCM 45 rotates the swing arm 42 in a direction determined by Fleming's left-hand rule according to an interaction between a current input to a VCM coil and a magnetic field of a magnet. More specifically, when the HDD of FIG. 1 is powered on and the disks 20 are rotated, the VCM 45 rotates the swing arm 42 counterclockwise to move the heads on recording surfaces of the disks 20. When the HDD is powered off and rotation of the disks 20 is stopped, the VCM 45 rotates the swing arm 42 clockwise to move the heads from the recording surfaces of the disks 20. When moved from the recording surfaces of the disks 20, the heads are parked on a ramp 46 provided outside of the disks 20.

When an upper part of the base member 11 is combined with a cover member 12 via a plurality of screws 19, the disks 20, the spindle motor 30, and the actuator 40 are enclosed and protected by the base member 11 and the cover member 12.

A structure in which the spindle motor 30, the disks 20, and the clamp 60 are combined will be described with reference to FIGS. 2 and 3.

FIG. 2 is a perspective, enlarged view of the clamp 60 of the conventional HDD of FIG. 1. FIG. 3 is a cross-sectional view of the clamp 60 of FIG. 1 that is combined with the spindle motor 30. Referring to FIGS. 2 and 3, the spindle motor 30 includes a shaft 31 and a hub 34 that is rotated while being coupled to the shaft 31. The disks 20 are mounted onto the hub 34. As is described above, when the plurality of disks 20 are mounted onto the spindle motor 30, the ring-shaped spacer 50 is further mounted onto the hub 34 to maintain an interval between the plurality of disks 20. A screw insertion hole 62, into which the screw 70 is inserted, is positioned in a center portion of the clamp 60, and a screw clamp hole 32, with which the screw 70 is combined, is positioned in a center portion of the shaft 31, so that the clamp 60 that fixes the disks 20 can be combined with an upper part of the spindle motor 30. When the screw 70 is clamped with the screw clamp hole 32 in the shaft 31 of the spindle motor 30, a clamping force makes an outer circumference 64 of the clamp 60 apply pressure onto upper parts of the disks 20 in the vertical direction, thereby enabling the disks 20 firmly be fixed onto the hub 34 of the spindle motor 30.

In the HDD shown in FIGS. 1-3, data is recorded on and/or reproduced from the disks 20 rotated at a high speed, using the write/read heads installed to be very slightly spaced from the disks 20. If the HDD is given an external impact, the impact is delivered to the disks 20 via the base member 11, the shaft 31 of the spindle motor 30, the screw 70, and the clamp 60. Also, vibration caused by rotation of the spindle motor 30 is transferred to the disks 20 via the shaft 31, the screw 70, and the clamp 60. The impact or vibration delivered to the disks 20 causes vibration of the disks 20, and makes the recording surfaces of the disks 20 bump against the heads, thereby damaging the surface of the disks 20 and/or the heads. Further, the vibration of the disks 20 deteriorates the reading/writing performance of the head.

### SUMMARY OF THE INVENTION

The present invention provides a disk clamping apparatus for a data storage device, in which a damper is installed between a clamp and an upper part of a spindle motor to damp an impact or vibration delivered to a disk via the clamp.

According to one aspect of the present invention, there is provided: a disk clamping apparatus for a data storage device, in which at least one disk is mounted onto a spindle motor, the disk clamping apparatus comprising a clamp combined with the spindle motor and applying pressure onto the disk in a first direction, an outer circumference of the clamp contacting a first part of the disk; and a damper installed between the clamp and the spindle motor, to damp impact or vibration delivered to the disk via the clamp.

According to one aspect, the damper is installed between a bottom of the clamp and an upper part of a hub of the spindle motor.

The damper is made of a visco-elastic material, and is adhered to at least one of the bottom of the clamp or the upper part of the hub.

According to one aspect, a screw clamp hole is positioned in a center portion of a shaft of the spindle motor, a screw insertion hole is positioned in a center portion of the clamp, and the clamp is combined with the shaft by engaging a screw with the screw clamp hole.

According to one aspect, the damper is ring shaped.

According to one aspect, a plurality of screw clamp holes are positioned in the upper part of the hub of the spindle motor, spaced equally along a circumference of the hub. A plurality of screw insertion holes are positioned in the clamp corresponding with the plurality of screw clamp holes. The clamp is combined with the hub by engaging a plurality of screws with the plurality of screw clamp holes.

According to one aspect, the damper is ring shaped and located at a position of the hub, such that the damper does not interfere with the plurality of screws.

According to one aspect, the damper is ring shaped and located at a position of the hub where the plurality of screw clamp holes are located, and a plurality of through-holes oriented in the first direction are positioned in the damper to correspond to the plurality of screw clamp holes, the plurality of screws being inserted through the plurality of through-holes.

According to one aspect, the damper is a plurality of dampers located among the plurality of screw clamp holes.

Additional aspects and/or advantages of the invention will be set forth in part in the description which follows, and in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a perspective, exploded view of a conventional hard disk drive (HDD);

FIG. 2 is a perspective, enlarged view of a clamp of the conventional HDD of FIG. 1;

FIG. 3 is a cross-sectional view of the clamp of FIG. 1 combined with a spindle motor;

FIG. 4 is a perspective, exploded view of a disk clamping apparatus for a data storage device according to an embodiment of the present invention;

FIG. 5A is a partial cross-sectional view of a clamp of FIG. 4 that has not yet been combined with a spindle motor;

FIG. 5B is a partial cross-sectional view of the clamp of FIG. 4 that is combined with the spindle motor;

FIG. 6 is a perspective, exploded view of a disk clamping apparatus for a data storage device according to another embodiment of the present invention;

FIG. 7 is a partial cross-sectional view of a clamp of FIG. 6 combined with a spindle motor; and

FIGS. 8 and 9 are partial perspective views of modified examples of a damper of FIG. 6.

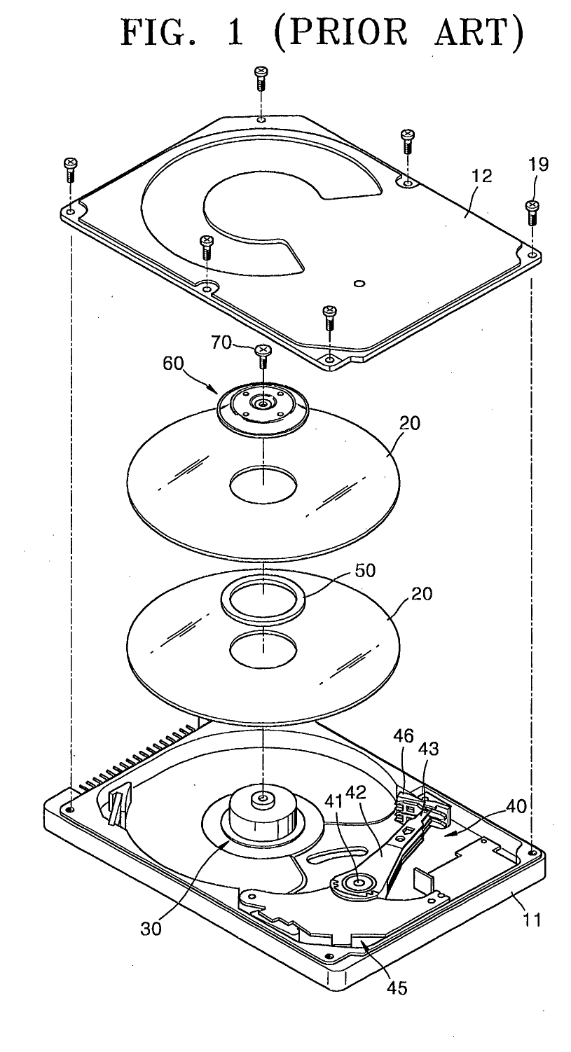

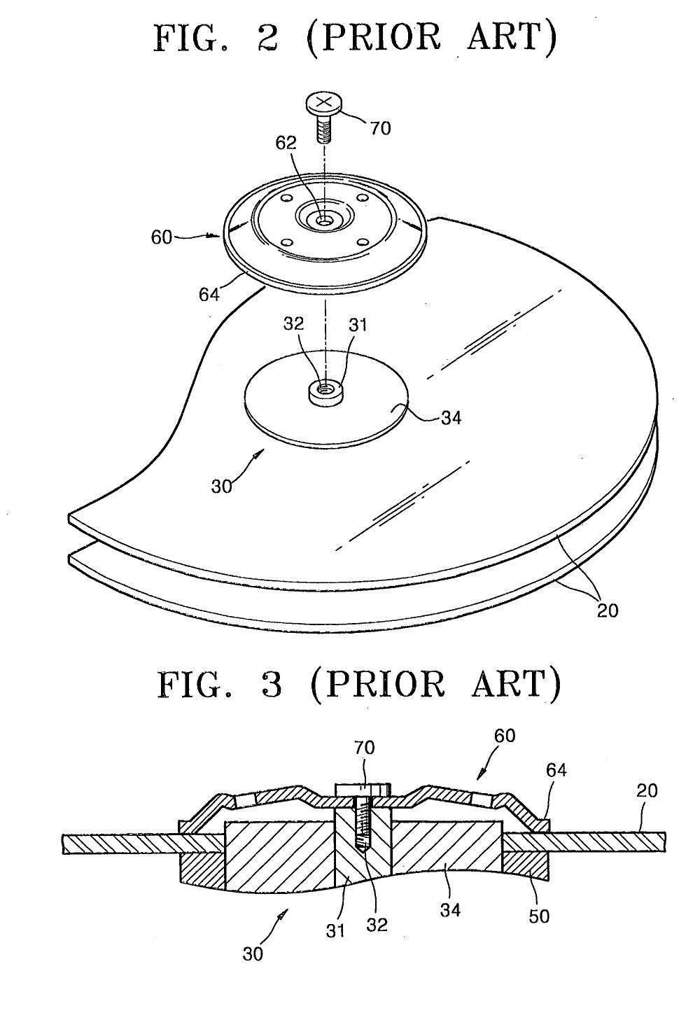

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The described embodiments explain the present invention by referring to the figures.

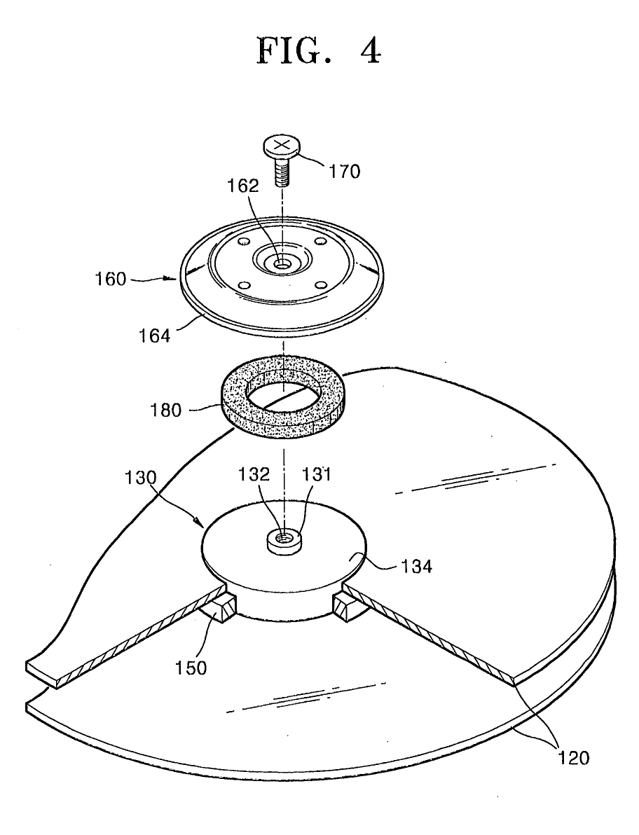

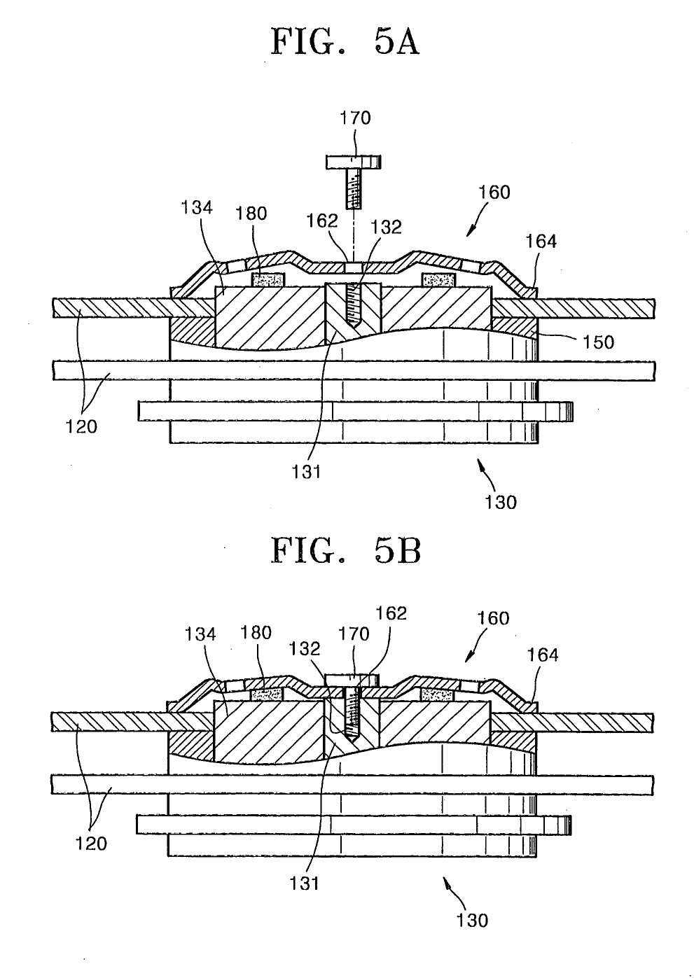

FIG. 4 is a partial, perspective view of a disc clamping apparatus for a data storage device according to an embodiment of the preset invention. FIG. 5A is a partial cross-sectional view of a clamp of FIG. 4 that has not yet been combined with a spindle motor according to the present invention. FIG. 5B is a partial cross-sectional view of the clamp of FIG. 4 that is combined with the spindle motor.

At least one disk 120 that is a data storage medium, a spindle motor 130 that rotates the disk 120, and a disk clamping apparatus are installed in a hard disk drive (HDD) (not shown) as a data storage device.

A structure of the spindle motor 130 is not limited to the illustrated embodiment. For example, the spindle motor 130 may include a ball bearing or a hydrodynamic bearing. According to one embodiment, the spindle motor 130 includes a shaft 131 and a hub 134 that is combined with the shaft 131. According to one embodiment, the, the spindle motor 130 is constructed such that the hub 134 is rotated together with the shaft 131.

The disk 120 is mounted onto the hub 134. In an embodiment where a plurality of disks 120 are mounted onto the hub 134, at least one ring-shaped spacer 150 is further mounted onto the hub 134 to maintain respective distances between respective disks 120.

The disk clamping apparatus includes a clamp 160 combined with an upper part of the spindle motor 130 and applying pressure onto the disk 120 in a vertical direction so that the disk 120 is firmly fixed onto the hub 134 of the spindle motor 130, and a damper 180 installed between the clamp 160 and an upper part of the hub 134.

According to one embodiment, the clamp 160 is fixed onto the shaft 131 of the spindle motor 130. For the fixing of the clamp 160, a screw clamp hole 132 is positioned in a center portion of the shaft 131 and a screw insertion hole 162 is positioned in a center portion of the clamp 160. The clamp 160 is fixed with the shaft 131 by engaging a screw 170 with the screw clamp hole 132. An outer circumference 164 of the clamp 160 contacts an upper part of the at least one disk 120 so that the clamp 160 applies pressure onto the at least one disk 120 in the vertical direction.

According to one embodiment, the clamp 160 is disk shaped and its center portion is swollen like a dome. As will be described later in detail, the clamp 160 has an elastic property, and therefore, when it is elastically deformed, the outer circumference 164 of the clamp 160 applies pressure onto the disk 120, thereby fixing the disk 120 onto the hub 134. According to one embodiment, the clamp 160 is made of an elastic metal material, such as stainless steel.

The damper 180 is installed between the clamp 160 and the upper part of the hub 134, thus buffering impacts and vibration delivered to the at least one disk 120 via the clamp 160. According to one embodiment, the damper 180 is made of a visco-elastic material with an excellent buffering property, for example, rubber. Also, the damper 180 has a ring shape along the circumference of the clamp 160, thereby obtaining a uniform damping effect. Further, an area of the damper 180 is maximized within an allowable range, to maximize damping efficiency. The damper 180 is adhered to the upper part of the hub 134 via glue or a double-face adhesive tape. Alternatively, the damper 180 is adhered to a bottom of the clamp 160 or both the upper part of the hub 134 and the bottom of the clamp 160.

The operation of a disk clamping apparatus according to an embodiment of the present invention will now be described. Referring to FIG. 5A, the damper 180 and the clamp 160 are arranged to a predetermined position of the spindle motor 130, such that the outer circumference 164 of the clamp 160 contacts the upper part of the disk 120. Next, the screw 170 is inserted into the screw insertion hole 162 in the clamp 160 and combined with the screw clamp hole 132 in the shaft 131 of the spindle motor 130.

Then, as is shown in FIG. 5B, a clamping force between the screw 170 and the shaft 131 causes the clamp 160 to be elastically deformed to a flat shape. An elastic force caused by the deformation of the clamp 160 makes the outer circumference 164 of the clamp 160 apply pressure onto the disk 120 in the vertical direction, thus firmly fixing the disk 120 onto the hub 134. In this case, the damper 180 is pressed by the clamp 160 and contacts the upper part of the hub 134 and the bottom of the clamp 160.

As is described above, the damper 180 installed between the clamp 160 and the hub 134 absorbs vibration of the clamp 160 caused when vibration due to impacts on the HDD or rotation of the spindle motor 130 is delivered to the clamp 160 via the shaft 131 of the spindle motor 130 and the screw 170. When the vibration of the clamp 160 is relieved by the damper 180, vibration of the disk 120 caused by impacts or vibration delivered via the clamp 60 is also reduced. Accordingly, it is possible to reduce incidences of the disk 120 bumping against the head and reduce deterioration of the performance of the head. Also, use of the damper 180 reduces vibration and noise of the spindle motor 130.

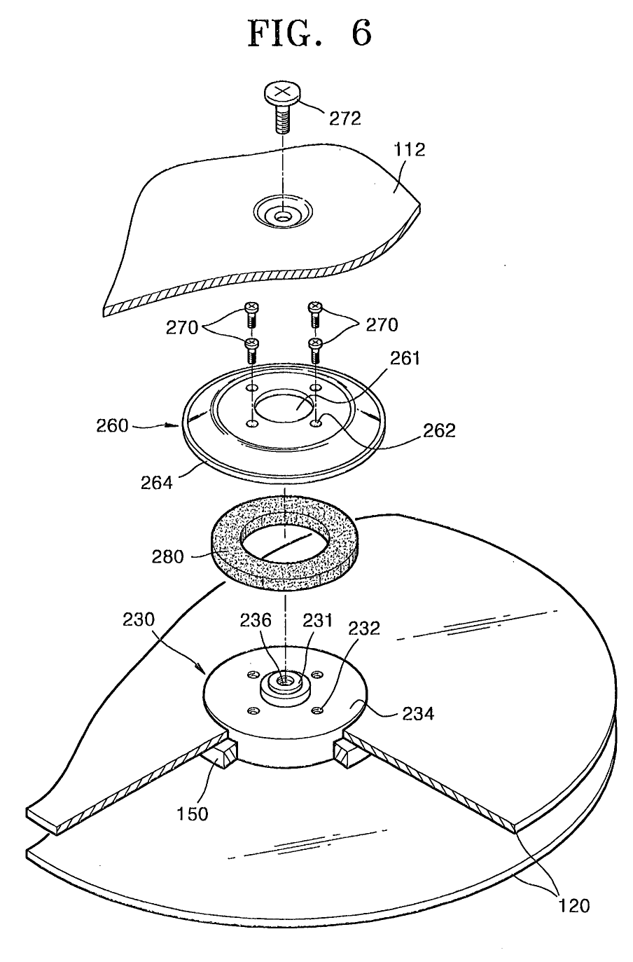

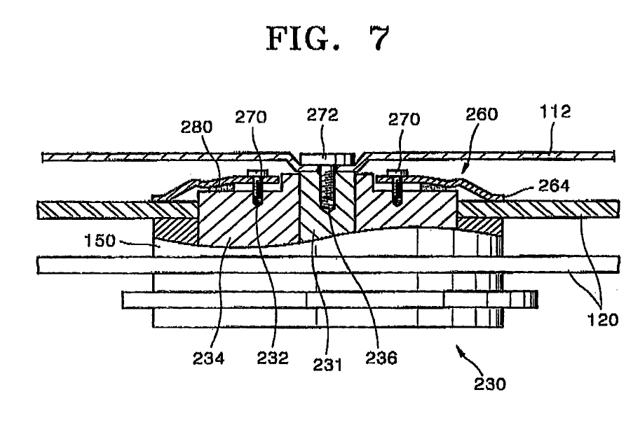

FIG. 6 is a perspective, exploded view of a disk clamping apparatus for a data storage device according to another embodiment of the present invention. FIG. 7 is a partial cross-sectional view of a clamp 260 of FIG. 6 that is combined with a spindle motor 230.

A structure of the spindle motor 230 is not limited to the illustrated embodiment. Referring to FIGS. 6 and 7, a shaft 231 is fixedly installed in the spindle motor 230, and a hub 234 is combined with the shaft 231, such that the hub 234 can rotate with respect to the shaft 231. Also, the shaft 231 is fixed with a cover member 112 of an HDD (not shown). Thus, a screw clamp hole 236, with which a screw 272 is engaged, is positioned in a center portion of the shaft 231. At least one disk 120 is mounted onto the hub 234. In an embodiment where a plurality of disks 120 are mounted onto the hub 234, at least one ring-shaped spacer 150 is mounted onto the hub 234 to maintain respective distances between respective disks 120.

A structure of the disk clamping apparatus of FIGS. 6 and 7 is configured so that the disk clamping apparatus is installed on the spindle motor 230. More specifically, the clamp 260, which applies pressure onto the disk 120 in the vertical direction, is combined with the hub 234 of the spindle motor 230. For the combination, a plurality of screw clamp holes 232 are positioned in an upper part of the hub 234 of the spindle motor 130, spaced equally along a circumference of the hub 234. Also, a plurality of screw insertion holes 262 are positioned in the clamp 260 to correspond to the plurality of screw clamp holes 232. The clamp 260 is combined with the hub 234 by engaging a plurality of screws 270 with the plurality of screw clamp holes 232. A hollow portion 261, into which the shaft 231 is inserted, is positioned in a center portion of the clamp 260, and an outer circumference 264 of the clamp 260 contacts an upper part of the disk 120, so that the outer circumference 264 applies pressure onto the disk 120 in the vertical direction. According to one embodiment, the center portion of the clamp 260 is swollen like a dome, and the clamp 260 is made of an elastic metal material, such as stainless steel. The operation of the clamp 260 is the same as that of the clamp 160, and thus, a description thereof will be omitted.

The disk clamping apparatus of FIGS. 6 and 7 includes a damper 280 installed between the clamp 260 and the upper part of the hub 234 of the spindle motor 230, to damp impacts or vibration delivered to the disk 120 via the clamp 260. In detail, like the damper 180, the damper 280 is a ring shape made of a visco-elastic material. The damper 280 is adhered to at least one of the upper part of the hub 234 or a bottom of the clamp 260.

According to one embodiment, the damper 280 is located such that the damper 280 does not interfere with the plurality of screws 270. For instance, as is shown in FIG. 7, the damper 280 is installed outside an area defined by the plurality of screws 270. According to another embodiment, the damper 280 is installed inside the area defined by the plurality of screws 270.

The operation of the damper 280 is the same as that of the damper 180, and thus a description thereof will be omitted.

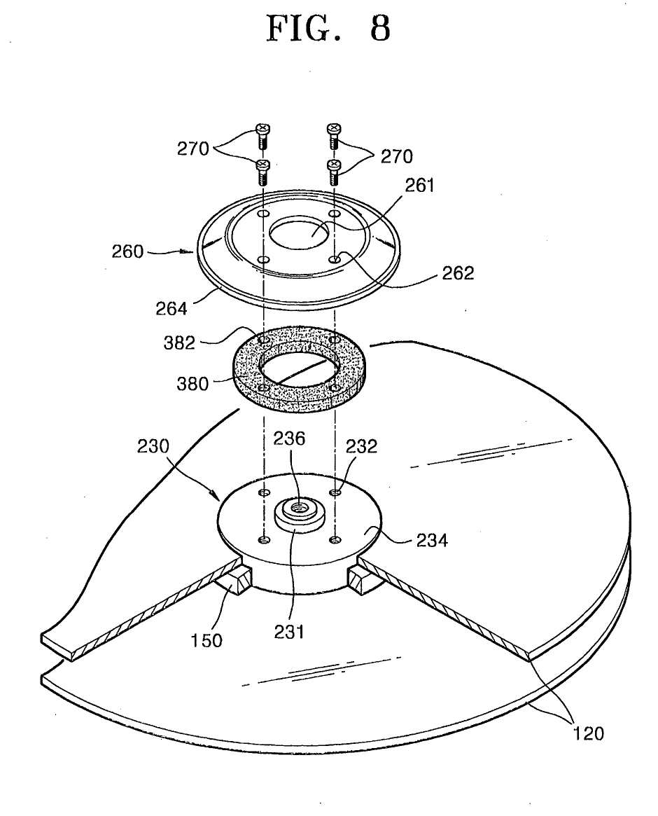

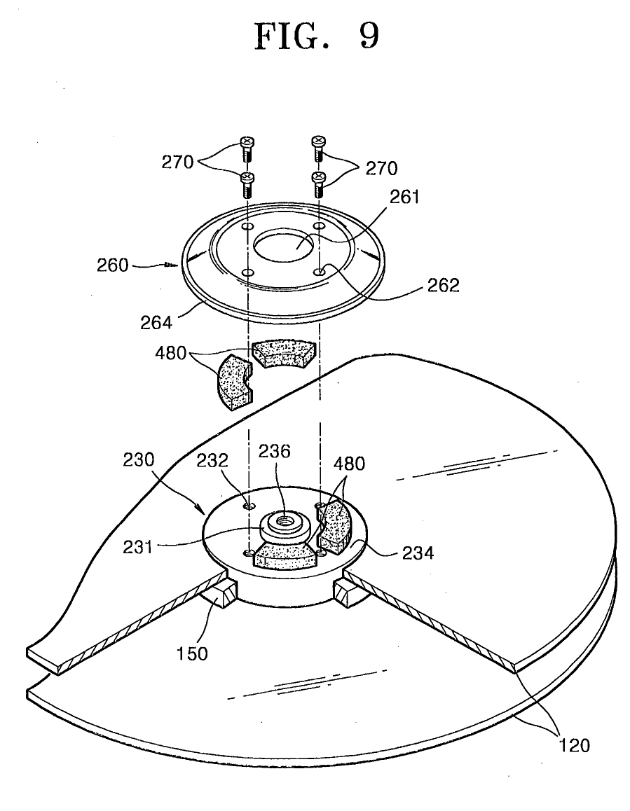

FIGS. 8 and 9 are partial perspective views of modified examples of the damper 280 in the disk clamping apparatus of FIG. 6. A ring-shaped damper 380 of FIG. 8 is installed between the clamp 260 and the upper part of the hub 234, and more particularly. According to one embodiment, the damper 380 is located on a position of the hub 234 where the plurality of screw clamp holes 232 are located. As is shown in FIG. 8, the damper 380 includes a plurality of vertical through-holes 382, into which the screws 270 are inserted, that correspond to the plurality of screw clamp holes 232.

Referring to FIG. 9, a plurality of dampers 480 are installed among the plurality of screw clamp holes 232 in the upper part of the hub 234, to damp vibration of the clamp 260. In other words, the respective dampers 480 are installed between adjacent pairs of the screw clamp holes 232.

As is described above, a damper 180, 280, 380, 480 is installed between a clamp 160, 260 and an upper part of a spindle motor 130, 230, to damp impacts and vibration delivered to the disk 120 via the clamp 160, 260, thereby minimizing vibration of the disk 120 caused by the impact and vibration. Accordingly, it is possible to reduce the occurrence of the disk 120 bumping against a head due to the vibration of the disk 120, and deteriorating the performance of the head. Also, use of the damper 180, 280, 380, 480 reduces vibration and noise of the spindle motor 130,230.

Additionally, although the present invention is described with respect to an HDD, it is applicable to different types of data storage devices, such as an optical disk drive.

Although a few embodiments of the present invention have been shown and described, it would be appreciated by those skilled in the art that changes may be made in these embodiments without departing from the principles and spirit of the invention, the scope of which is defined in the claims and their equivalents.

1. A disk clamping apparatus for a data storage device in which at least one disk is mounted onto a spindle motor, the disk clamping apparatus comprising:
a clamp combined with the spindle motor and applying pressure onto the disk in a first direction, an outer circumference of the clamp contacting a first part of the disk; and
a damper installed between the clamp and the spindle motor to damp impact or vibration delivered to the disk via the clamp.

2. The disk clamping apparatus of claim 1, wherein the damper is installed between a bottom of the clamp and an upper part of a hub of the spindle motor.

3. The disk clamping apparatus of claim 2, wherein the damper is adhered to at least one of the bottom of the clamp or the upper part of the hub.

4. The disk clamping apparatus of claim 1, wherein:
a screw clamp hole is positioned in a center portion of a shaft of the spindle motor;
a screw insertion hole is positioned in a center portion of the clamp; and
the clamp is combined with the shaft by engaging a screw with the screw clamp hole.

5. The disk clamping apparatus of claim 4, wherein the damper is ring shaped.

6. The disk clamping apparatus of claim 1, wherein:
a plurality of screw clamp holes are positioned in a first part of a hub of the spindle motor, spaced equally along the circumference of the hub;
a plurality of screw insertion holes are positioned in the clamp corresponding with the plurality of screw clamp holes; and
the clamp is combined with the hub by engaging a plurality of screws with the plurality of screw clamp holes.

7. The disk clamping apparatus of claim 6, wherein the damper is ring shaped and located at a position of the hub, such that the damper does not interfere with the plurality of screws.

8. The disk clamping apparatus of claim 6, wherein:
the damper is ring shaped and located at a position of the hub where the plurality of screw clamp holes are located; and
a plurality of through-holes oriented in the first direction are positioned in the damper to correspond with the plurality of screw clamp holes, the plurality of screws being inserted through the plurality of vertical through-holes.

9. The disk clamping apparatus of claim 6, wherein the damper comprises a plurality of dampers, located among the plurality of screw clamp holes.

10. The disk clamping apparatus of claim 1, wherein the damper is made of a visco-elastic material.

11. A disk clamping apparatus for a data storage device having a disk mounted on a hub of a spindle motor, the disk clamping apparatus comprising:
a clamp connected with the spindle motor and fixing the disk with respect to the hub; and
a damper disposed between the hub and the clamp, to buffer impact and vibration imparted to the disk via the clamp.

12. The disk clamping apparatus according to claim 11, wherein the damper is made of a visco-elastic material.

13. The disk clamping apparatus according to claim 11, wherein:
the damper is ring-shaped; and
the damper is positioned approximately concentrically with respect to the clamp, to provide a uniform damping effect.

14. The disk clamping apparatus according to claim 11, wherein the damper is adhered to at least one of a surface of the hub adjacent to the clamp, or a surface of the clamp adjacent to the hub.

15. The disk clamping apparatus according to claim 11, wherein:
a shaft is fixedly installed in the spindle motor;
the hub is rotatably combined with the shaft;
the shaft is fixedly connected to a cover member of the data storage device;
a surface of the hub adjacent to the clamp has a plurality of connector clamp holes; and
the clamp has
a plurality of connector insertion holes, each corresponding with one of the connector clamp holes, via which respective connectors connect the clamp with the hub, and
a hollow portion, through which the shaft passes.

16. The disk clamping apparatus according to claim 15, wherein the damper is positioned to not interfere with the connectors.

17. The disk clamping apparatus according to claim 15, wherein the damper is positioned one of inside or outside of a circumference defined by the connectors.

18. The disk clamping apparatus according to claim 15, wherein the damper has a plurality of through holes, each corresponding with one of the connector clamp holes, through which the respective connectors connect the clamp with the hub.

19. The disk clamping apparatus according to claim 15, wherein the damper comprises a plurality of dampers located among the plurality of connector clamp holes.

20. The disk clamping apparatus according to claim 15, wherein the damper comprises a plurality of dampers, respective dampers being installed between adjacent pairs of the connector clamp holes.
